(19) United States
(12) Patent Application Publication
(10) Pub. No.: US 2010/0107863 A1
(43) Pub. Date: May 6, 2010

(54) DEVICE MEANT FOR CONTROLLING OF AN OSCILLATING CYLINDER

(76) Inventor: Vesa Ropponen, Huittinen (FI)

Correspondence Address: STITES & HARBISON PLLC, 1199 NORTH FAIRFAX STREET, SUITE 900, ALEXANDRIA, VA, 22314, US

(21) Appl. No.: 12/514,614

(22) PCT Filed: Nov. 13, 2007
(86) PCT No.: PCT/FI2007/000273

§ 371 Date: Jan. 20, 2010

(30) Foreign Application Priority Data
Nov. 13, 2006 (FR) 2006991

(51) Int. Cl. F15B 15/04; F15B 11/15

(52) U.S. Cl. 91/286; 91/306; 91/311; 60/369; 60/397

(57) ABSTRACT

An arm structure intended for controlling the impulse valve (5) of the oscillating cylinder which performs a back and forth movement whereupon the oscillating cylinder comprises a cylinder body (14), a cylinder chamber (1) formed into the mentioned body, a piston (2) which can be moved in the cylinder chamber with the help of a pressure media, feeding channels (15, 16, 17) of the pressure media to the cylinder chamber (1) and control devices in order to direct the pressure media to the cylinder chamber to various sides of the piston and away from the cylinder chamber in order to achieve a back and forth movement for the piston and whereupon the impulse valves (5) belong to the control devices the operation of which at least one arm (10); (12), which explores mechanically the position of the piston arm (7) the movement of which arm is adjusted to open the pressure relieving channel of the impulse valve (5). The contact element which can be moved in relation to the arm, is adjusted to the arm which contact element opens the mentioned pressure relieving channel.

The invention relates to a device which is intended for controlling an oscillation cylinder which performs a back and forth movement whereupon the oscillating cylinder comprises a cylinder body, a cylinder chamber which is formed inside the mentioned body, a piston which can be moved in the cylinder chamber with the help of a pressure media, feeding channels of the pressure media leading to the cylinder chamber and control devices in order to direct the pressure media to the cylinder chamber to various sides of a piston and away from the cylinder chamber in order to create a back and forth movement to the piston and whereupon impulse valves belong to the control devices the operation of which is controlled on its behalf by at least one arm which explores the position of the piston arm mechanically, the movement of which arm is adjusted to open the pressure relieving channel of the impulse valve.

Oscillating cylinders, in which the position of the piston arm is explored mechanically with the help of bars and arms, are previously known and the wafers or corresponding elements which have been attached to the piston arm are adjusted to contact the mentioned arms at the desired turning point of the movement of the piston. A little movement, which is generated because of for example the contact of the above mentioned wafer to these arms, transfers the arm in touch with the impulse valve and the arm opens the pressure relieving valve which is located in the impulse valve in such a way that the impulse valve directs the piston to change the movement direction as a result of this. The arm is located very close to the impulse valve in such a way that the movement of the arm contacts the opening element located in the impulse valve. These kind of solutions are known for example from the publications FI-20041503, U.S. Pat. Nos. 3,620,326, 4,680,930, DE 803271.

In the known solutions the position of the turning movement of the piston has to be adjusted by transferring elements which are attached to the piston arm, such as wafers. The wafers are in the piston arm which comes out of the end of the oscillating cylinder and their adjustments have to be done in an narrow space among impulse valves by for example transferring and locking the wafers to a different position on the surface of the piston arm. The wafers can knowingly be transferred also by turning them at the spiral which is located on the surface of the piston arm and in addition to that with the help of the locking screw the rotation of them is prohibited when they have reached the adjusted position. For these adjustment operations a tool is needed which has to be fitted into the space which is available or otherwise something else still has to be taken away from the frontside. In addition to this oscillating movement of the cylinder has to be stopped during the adjustment. After the adjustment the cylinder still needs to be tested and it has to be observed whereto the turning points of the piston have been located and possibly adjust them one more time.

In order to remove the above mentioned disadvantages a new arm structure, which controls the pressure relieving valve of the impulse valve, has been developed which is intended for controlling the oscillating cylinder, for which it is characteristic that a contact element, which is moveable in regard to the arm, has been adjusted to the arm which contact element opens the mentioned pressure relieving channel.

The advantage of the device according to the invention which controls the turning points of the oscillating cylinder is the fact that elements such as wafers which have been attached to to the piston arm do not have to be transferred when a little bit different moving distance has been searched for the piston of the cylinder. The screws which are in the moving arms are easy to turn to the new depth whereupon the turning point of the piston can be made to move already a couple of millimeters. The impulse valves can be turned in such a position and screws can be directed in such a position that screws can be turned even when the piston is moving. The element which opens the impulse valve does not need to be the mentioned rotating screw itself, but with the help of the screw such a contact element can be transferred indirectly which opens the impulse valve.

In the following the invention is described more detailed by referring to the accompanying drawing in which

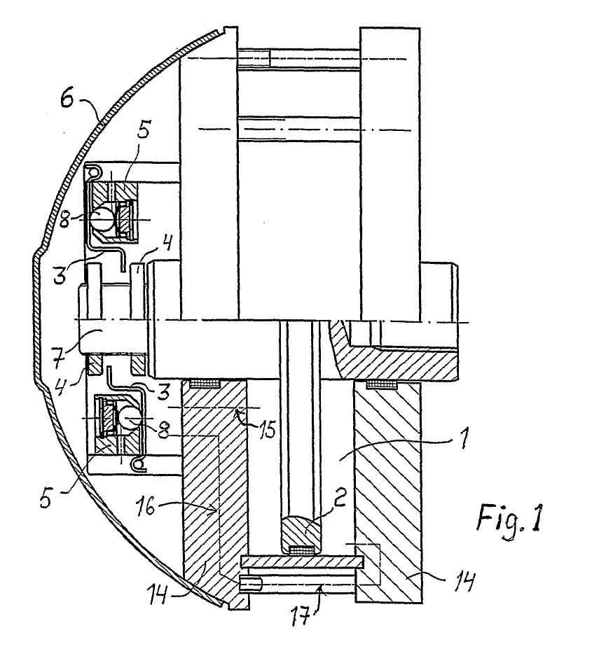

FIG. 1 shows one known oscillating cylinder equipped with impulse valves as a section view.

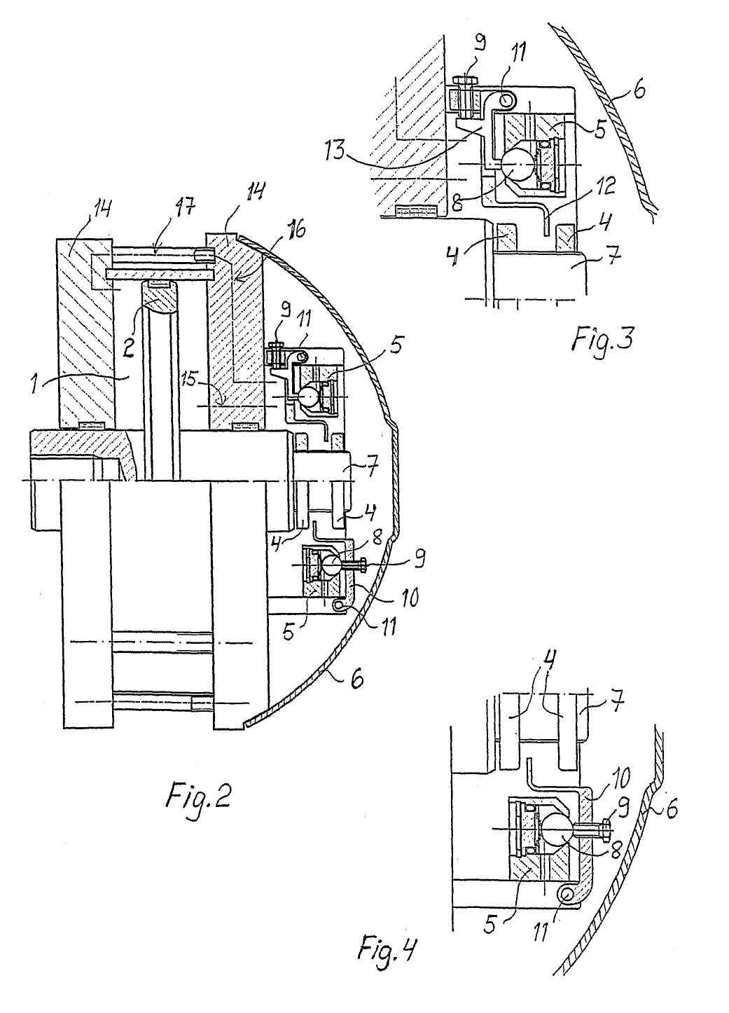

FIG. 2 shows an oscillating cylinder according to the invention, equipped with impulse valves as a section view.

FIG. 3 shows one arm system attached to the impulse valve.

FIG. 4 shows another arm system attached to the impulse valve.

In FIG. 1 a known oscillating cylinder is shown comprising a cylinder chamber 1, piston 2 and piston arm 7. Movement restrictors such as wafers 4 have been turned to the surface of the piston arm 7. The wafers 4 can be transferred by turning them to different positions at the piston arm 7. Impulse valves 5, which are adjusted to open with the help of the arm 3 when the arms 3 contact the wafers 4, control the turning point of the piston of the cylinder at the both ends of the movement. The movement of the balls 8 of the impulse valves opens the channel and relieves the pressure coming from the actual control valve of the cylinder 1 and causes movement of the control shaft in the control valve between two positions so that in one position the piston 2 is directed to move to the right hand side and in another to the left hand side. When one wants to change the moving distance of the cylinder a little, the wafers 4 have to be moved by turning them and at the same by holding the piston arm 7 so that turning of it becomes prohibited.

In order to eliminate slight difficulties in the above mentioned adjusting, a new structure is shown in the FIG. 2 as an adjustment device in which figure two different impulse valve solutions 5 have been attached to the same oscillating cylinder. The FIG. 4 shows an enlargement of a more simple solution in which screw 9, the top of which is arranged get connected to the balls 8 which opens the impulse valve 5, is adjusted to the arm 10 which turns with the help of a hinge 11. The screw 9 is easy to turn and if wanted, the impulse valve can be turned to another position whereupon the screw 9 can be turned, if needed, from the easier direction if there are hinders at the installation location. The arms 10 hardly move when the cylinder is operating so that the adjustment can be done even when the cylinder is operating,

The adjustment screw 9 located in the arm 19 can also be adjusted to move one of any elements which moves in relation to the arm when the element is just about to touch the pellet 8. The direction of the screw can then be arranged to something else, too. The solution of the FIG. 3 is one example of such a thing in which another turning arm 13, which comes in touch with the ball 8 and opens the valve, is attached to the same hinge 11 with the moving arm 12. The arm 12 moves the arm 13 with the help of the screw 9. With the help of the screw 9 the position between the arms 12, 13 can be changed whereupon the arm 13 can be adjusted to contact the ball 8 with different positions of the arm 12 between the wafers 4. In this case the adjustment screw 9 is in an advantageous direction regarding the adjusting performance. For example the direction of the piston arm 7 and the direction of the radius of the piston arm 7 are advantageous directions to the adjustment screw 9.

1. An arm structure intended for controlling the impulse valve (5) of the oscillating cylinder which performs a back and forth movement whereupon the oscillating cylinder comprises a cylinder body (14), a cylinder chamber (1) formed into the mentioned body, a piston (2) which can be moved in the cylinder chamber with the help of a pressure media, feeding channels (15, 16, 17) of the pressure media to the cylinder chamber (1) and control devices in order to direct the pressure media to the cylinder chamber to various sides of the piston and away from the cylinder chamber in order to achieve a back and forth movement for the piston and whereupon the impulse valves (5) belong to the control devices the operation of which at least one arm (10); (12), which explores mechanically the position of the piston arm (7) the movement of which arm is adjusted to open the pressure relieving channel of the impulse valve (5), characterized in that contact element which can be moved in relation to the arm, is adjusted to the arm which contact element opens the mentioned pressure relieving channel.

2. Device according to claim 1, characterized in that the contact element is a rotating screw (9).

3. Device according to claim 1, characterized in that the contact element is a moveable part (13) in relation to the arm with the help of the screw (9).

4. Device according to claim 1, characterized in that the adjustment element, such as the screw (9) is directed to be turned in a direction to the radius of the piston arm (7) or to be turned in a direction of the piston arm.
